(19) United States
(12) Patent Application Publication
(10) Pub. No.: US 2018/0068284 A1
(43) Pub. Date: Mar. 8, 2018

(54) METHOD AND SYSTEM FOR BROWSER-INTEGRATED GENERATION OF CONTROLLED PAYMENT NUMBERS

(71) Applicant: MasterCard International Incorporated, Purchase, NY (US)

(72) Inventor: Srinivasa WUDARU, Chesterfield, MO (US)

(73) Assignee: MasterCard International Incorporated, Purchase, NY (US)

(21) Appl. No.: 15/259,767

(22) Filed: Sep. 8, 2016

(51) Int. Cl. G06Q 20/10; H04L 29/08; G06Q 20/40; G06Q 20/14

(52) U.S. Cl. CPC G06Q 20/102; G06Q 20/14; G06Q 20/401; H04L 67/02

(57) ABSTRACT

A method for automatic generation and usage of a controlled payment number includes: storing at least an account identifier; receiving web page data originating from a first computing system, the data including a form having a plurality of input fields including a primary account number field and additional web page code; receiving an instruction for generation of a controlled payment number; extracting a transaction amount from the additional web page code; transmitting the account identifier and extracted transaction amount to a second computing system; receiving payment data from the second computing system including a controlled payment number, the number being subject to transaction controls including a spending limit based on the extracted transaction amount; and inputting the controlled payment number into the primary account number field.

### FIELD

The present disclosure relates to the automatic generation and usage of controlled payment numbers, specifically the automatic generation of controlled payment numbers in a web browsing environment that are subject to transaction controls based on a proposed payment transaction parsed from the web browsing environment.

### BACKGROUND

Consumers use web browsers to engage in payment transactions with merchants to purchase a variety of different goods and services. Traditionally, consumers have used their standard transaction account in order to fund e-commerce transactions that are conducted using a web browser. However, some consumers have become wary of using their standard account information on online-based transactions due to the danger of the information being compromised due to security breaches. As a result, such consumers have sought alternative methods for funding e-commerce transactions where the theft of payment credentials may be less detrimental to the consumer.

One such method includes the use of controlled payment numbers. Controlled payment numbers are numbers that are linked to a transaction account that are used in place of the transaction account's standard account number, that are subject to transaction controls. The transaction controls may place limits on the usage of the controlled payment number, such as a limit on the overall number of transactions, individual transaction amount, aggregate transaction amount, etc. As a result, the theft of a controlled payment number may be less detrimental to the consumer as the controlled payment number may be limited in its use such that the thief may be unable to use a significant amount of money, or may even be unable to transact entirely using the number.

While controlled payment numbers may be helpful for consumers, many consumers may face difficulties when obtaining a controlled payment number. For example, in many cases a consumer may have to obtain the controlled payment number before navigating to the merchant web site, or must leave the merchant web site to obtain a controlled payment number, which may be inconvenient and time-consuming for the consumer. In addition, the consumer may be unsure of the eventual transaction amount for their transaction, and may end up overestimating the amount when obtaining the controlled payment number, leaving an amount open that could be compromised, or may underestimate the amount and have to go back to the provider to modify the limits on their new controlled payment number in order to be able to conduct the transaction.

Thus, there is a need for a technical solution where controlled payment numbers may be automatically generated at a computing device during the initiation of a payment transaction that are limited to aspects of the specific transaction for which they are generated.

### SUMMARY

The present disclosure provides a description of systems and methods for the automatic generation and usage of a controlled payment number. The controlled payment number may be generated automatically while using the web browsing application program and may be subject to transaction controls that are generated from parsing the web page itself. The result may be a controlled payment number that is limited in its usage to the specific transaction being conducted, thus providing the consumer with the highest level of both convenience and security when conducting Internet- and other online-based transactions.

A method for automatic generation and usage of a controlled payment number includes: storing, in a memory of a computing device, an account data entry, wherein the account data entry includes a structured data set related to a transaction account including at least an account identifier; receiving, by a receiving device of the computing device, a first data signal superimposed with web page data originating from a first computing system, wherein the web page data includes data related to a web site including at least a form having a plurality of input fields including a field associated with a primary account number and additional web page code; receiving, by an input device of the computing device, an instruction for automatic generation of a controlled payment number for use with the website; extracting, by an analytic module of the computing device, at least a transaction amount from the additional web page code included in the web page data; electronically transmitting, by a transmitting device of the computing device, a second data signal superimposed with at least the account identifier and the extracted transaction amount to a second computing system; receiving, by the receiving device of the computing device, a third data signal superimposed with payment data from the second computing system, wherein the payment data includes at least a controlled payment number, the controlled payment number being associated with the transaction account and subject to one or more transaction controls including a spending limit based on the extracted transaction amount; and inputting, by a data supply module of the computing device, the controlled payment number into the field associated with a primary account number included in the form included in the web page data.

A system for automatic generation and usage of a controlled payment number includes: a data supply module of a computing device; a memory of the computing device configured to store an account data entry, wherein the account data entry includes a structured data set related to a transaction account including at least an account identifier; a receiving device of the computing device configured to receive a first data signal superimposed with web page data originating from a first computing system, wherein the web page data includes data related to a web site including at least a form having a plurality of input fields including a field associated with a primary account number and additional web page code; an input device of the computing device configured to receive an instruction for automatic generation of a controlled payment number for use with the website; an analytic module of the computing device configured to extract at least a transaction amount from the additional web page code included in the web page data; and a transmitting device of the computing device configured to electronically transmit a second data signal superimposed with at least the account identifier and the extracted transaction amount to a second computing system. The receiving device of the computing device is further configured to receive a third data signal superimposed with payment data from the second computing system, wherein the payment data includes at least a controlled payment number, the controlled payment number being associated with the transaction account and subject to one or more transaction controls including a spending limit based on the extracted transaction amount. The data supply module of the computing device is configured to input the controlled payment number into the field associated with a primary account number included in the form included in the web page data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the automatic generation and usage of controlled payment numbers for e-commerce transactions in accordance with exemplary embodiments.

FIG. 2 is a block diagram illustrating the computing device of FIG. 1 for the automatic generation and usage of controlled payment numbers in accordance with exemplary embodiments.

FIGS. 3A and 3B are a flow diagram illustrating a process for the automatic generation and usage of a controlled payment number in an e-commerce transaction using the system of FIG. 1 in accordance with exemplary embodiments.

FIG. 4 is a flow chart illustrating an exemplary method for automatic generation and usage of a controlled payment number in accordance with exemplary embodiments.

FIG. 5 is a flow diagram illustrating the processing of a payment transaction in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Automatic Generation and Usage of Controlled Payment Numbers

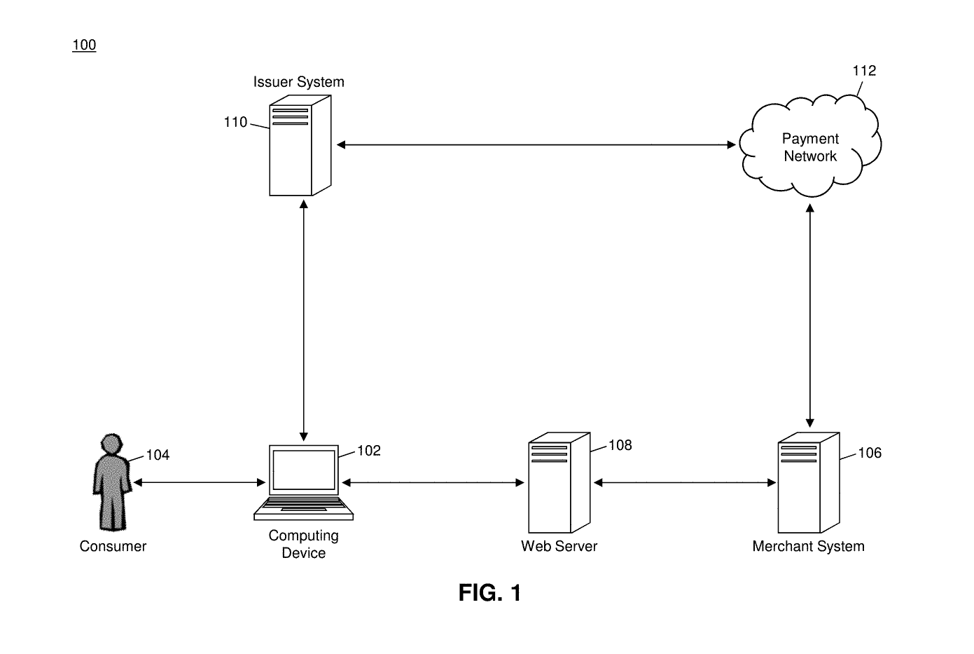

FIG. 1 illustrates a system 100 for the automatic generation and usage of controlled payment numbers in payment transactions initiated in a web-browsing environment that are limited based on data parsed directly from the web page used in initiation of the payment transaction.

The system 100 may include a computing device 102. The computing device 102, discussed in more detail below, may be configured to initiate the automatic generation of a controlled payment number that is limited based on transaction data for a payment transaction being conducted via a web page for usage in the payment transaction. The computing device 102 may be any type of computing device suitable for performing the functions discussed herein, such as a desktop computer, laptop computer, notebook computer, tablet computer, cellular phone, smart phone, smart watch, wearable computing device, implantable computing device, etc. The computing device 102 may include a web browsing application program executable thereby that is used by a consumer 104 as a user of the computing device 102 to navigate to web pages using methods and systems that will be apparent to persons having skill in the art.

The consumer 104 may use the web browsing application program of the computing device 102 to navigate to a web page associated with a merchant system 106. In some embodiments, the web page may be hosted by, and the corresponding web page data thus provided to the computing device 102 by, the merchant system 106. In other embodiments, the web page may be hosted by a web server 108 that is hired by, operated by, managed by, or otherwise associated with the merchant system 106. The web page navigated to by the computing device 102 may include at least a form and additional web page data.

The form may be a form used for the submission of payment information and other data required of the consumer 104 in order to initiate the processing of the payment transaction. The form may include a plurality of inputs fields for the input of the required data, such as at least an input field configured to store a primary account number. Additional input fields may be configured to store input of the shipping and/or billing information, such as an address, zip or postal code, city, state, country, etc.; gifting information; packaging or delivery instructions; additional payment data, such as an expiration date and security code; etc. The additional web page data may include at least information associated with the payment transaction to be initiated. Such information may include at least a transaction amount for the payment transaction. Additional information may also include a merchant identifier, merchant name, subtotal, tax amount, merchant location, product identifier, product name, product cost, etc.

The computing device 102 may receive the web page data and may be configured to parse the additional web page data included therein to identify at least the transaction amount for the payment transaction. The computing device 102 may then electronically transmit a request for a controlled payment number to an issuer system 110 using a suitable communication network and method, such as a cellular communication network or the Internet. The issuer system 110 may be configured to generate and provision controlled payment numbers that are associated with transaction accounts and subject to one or more transaction controls. In some instances, the issuer system 110 may be associated with a financial institution, such as an issuing bank, that issues the transaction accounts for which controlled payment numbers are generated. In other instances, the issuer system 110 may be separate from the financial institution that issues the transaction accounts.

The request for a controlled payment number may include at least an account identifier and the transaction amount parsed from the additional web page data. In some instances, the request may also include additional transaction data parsed from the additional web page data for use as basis of the transaction controls for the controlled payment number to be generated. The account identifier may be a unique value associated with one or more transaction accounts for use in identification thereof. The account identifier may be any value suitable for use in identification, such as a username, e-mail address, telephone number, registration number, identification number, etc. In some cases, the account identifier may be the account number for the transaction account to which the generated controlled payment number is to be associated. In instances where the account identifier may be associated with multiple transaction accounts, such as if the consumer 104 registered for the generation of controlled payment numbers for several transaction accounts, the account identifier may be accompanied by an additional identifier used to identify the transaction account to which the generated controlled payment number is to be associated.

The issuer system 110 may receive the request and may generate or otherwise identify a controlled payment number based thereon. The controlled payment number may be associated with the transaction account corresponding to the account identifier or other identification information included in the request. The association of the controlled payment number to the transaction account may include a mapping of the controlled payment number to the account number of the transaction account for swapping during processing of the payment transaction, as discussed in more detail below. The controlled payment number may be subject to one or more transaction controls that may control the usage of the controlled payment number in payment transactions. Transaction controls may include controls on a spending amount, an aggregate spending amount, number of transactions, transaction frequency, transaction time, transaction date, geographic location, merchant, merchant category, products purchased, product types, etc.

The controlled payment number identified by the issuer system 110 may include at least one transaction control on spending amount, which may be a limit on the transaction amount for the payment transaction. In some instances, the controlled payment number may also include a transaction control on the transaction time and date, which may be based on the time the request is received, such that the payment transaction must be conducted within a predetermined period of time of receipt of the request, such as five minutes, ten minutes, etc. In some such instances, the predetermined period of time may be based on the merchant or merchant category. In instances where the request includes additional transaction data, additional transaction controls may be applied to the controlled payment number, such as limiting the usage to the merchant associated with the web page, to the products indicated in the web page, etc.

Once the controlled payment number that is subject to the transaction controls is identified, it may be electronically transmitted to the computing device 102 using a suitable communication network and method. The computing device 102 may receive the controlled payment number, which may be input into the form of the web page. In some embodiments, the computing device 102 may automatically fill the input field configured to store the primary account number with the received controlled payment number. In other embodiments, the computing device 102 may display the controlled payment number to the consumer 104 and may request consumer confirmation prior to input of the controlled payment number, or may require the consumer to manually input the controlled payment number. In some instances, the computing device 102 may be configured to automatically fill additional input fields in the form. In such instances, the input fields may be automatically filled using locally stored data, such as may have been previously provided by the consumer 104, such as during a registration process, which may include, for example, billing address, shipping address, etc. In some cases, the computing device 102 may automatically submit the form once the controlled payment number has been received and input into the corresponding input field.

The form may be submitted, which may electronically transmit the data input into the input fields to the merchant system 106 (e.g., via the web server 108, if applicable). The merchant system 106 may receive the form and the data included therein, which may include at least the controlled payment number as the primary account number, as well as any additional data including additional payment credentials, billing address, shipping address, delivery instructions, etc. The merchant system 106 may submit the controlled payment number, additional payment credentials, and additional transaction data, collectively referred to herein as “transaction data,” to a payment network 112 for processing of the payment transaction. In some embodiments, the merchant system 106 may submit the transaction data directly to the payment network 112 via payment rails associated therewith. In other embodiments, the merchant system 106 may electronically transmit the transaction data to one or more intermediate entities for forwarding to the payment network 112, such as an acquiring institution or a gateway processor.

The payment network 112 may receive the transaction data and may process the payment transaction accordingly. In some embodiments, the transaction data may be formatted (e.g., by the merchant system 106 or an intermediate entity) in a transaction message. A transaction message may be a specially formatted data message that is formatted pursuant to one or more standards governing the exchange of financial transaction messages, such as the International Organization of Standardization's ISO 8583 or ISO 20022 standards. Transaction messages may include message type indicators indicative of a type of the transaction message and a plurality of data elements, with each data element being configured to store transaction data, such as a data element configured to store the primary account number. In some cases, a transaction message may also include one or more bitmaps, which may be configured to indicate the data elements included in the transaction message and the data stored therein.

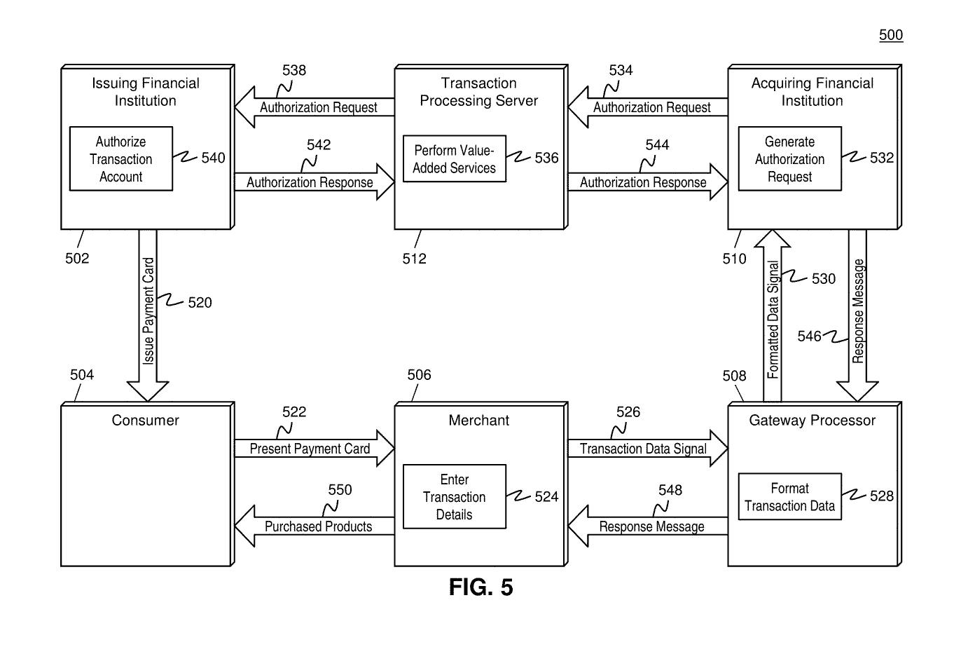

The payment network 112 may receive the transaction message for the payment transaction, which may include the controlled payment number stored in a corresponding data element included therein. The payment network 112 may then process the payment transaction using traditional methods and systems. Additional information regarding transaction messages and the processing of payment transactions is discussed in detail below with respect to the process 500 illustrated in FIG. 5. As part of the processing of the payment transaction, the transaction message may be electronically transmitted to the issuer system 110. The issuer system 110 may analyze the data stored in the data elements included in the transaction message to determine if the payment transaction is in compliance with the transaction controls associated with the controlled payment number used in the payment transaction. If the payment transaction is not in compliance, the issuer system 110 may return a response transaction message indicated as an authorization response that includes a data element configured to store a response code that indicates the payment transaction is denied.

If the payment transaction is in compliance, the issuer system 110 may swap the controlled payment number for the corresponding account number for the transaction account. The payment transaction may then be further processed by the transaction account's issuing institution (e.g., the issuer system 110, if applicable), such as for approving or denying the payment transaction, using traditional methods and systems. In some embodiments, the issuer system 110 may be configured to swap the account number back to the controlled payment number prior to the transaction message being returned to the payment network 112. Once the payment network 112 has received the transaction message, which may be an authorization response indicating approval or denial of the payment transaction, the payment network 112 may finalize the payment transaction accordingly.

The methods and systems discussed herein provide the automatic generation and usage of a controlled payment number for a payment transaction initiated via a web page. The specialized configuration of the computing device 102 as discussed herein may enable a controlled payment number to be generated that is limited to the specific payment transaction for which it is being generated, without requiring the input of transaction controls by the consumer 104. As a result, the consumer 104 may receive a controlled payment number that is suitable for their payment transaction that cannot be used outside of that payment transaction with minimal interaction, thus providing the consumer with a high level of convenience, while still being able to transact with a high level of confidence in their account security.

### Computing Device

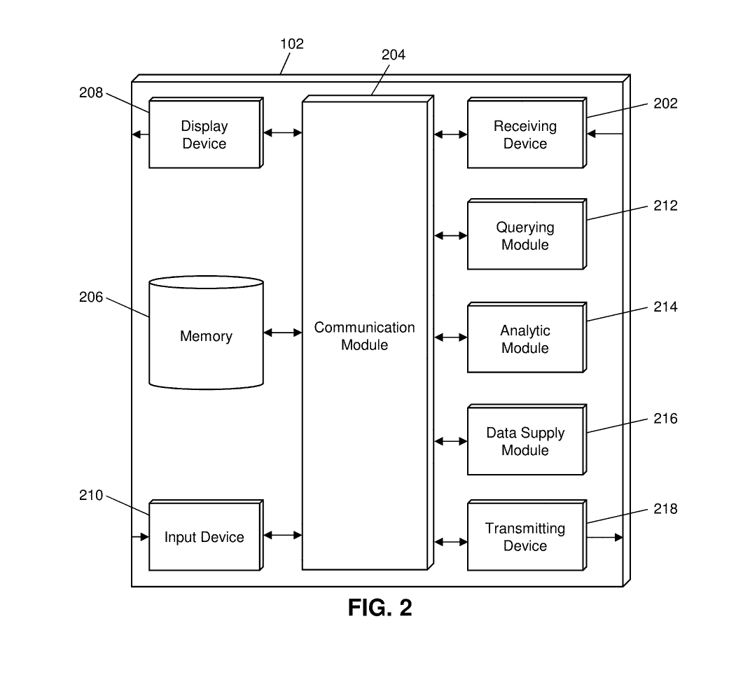

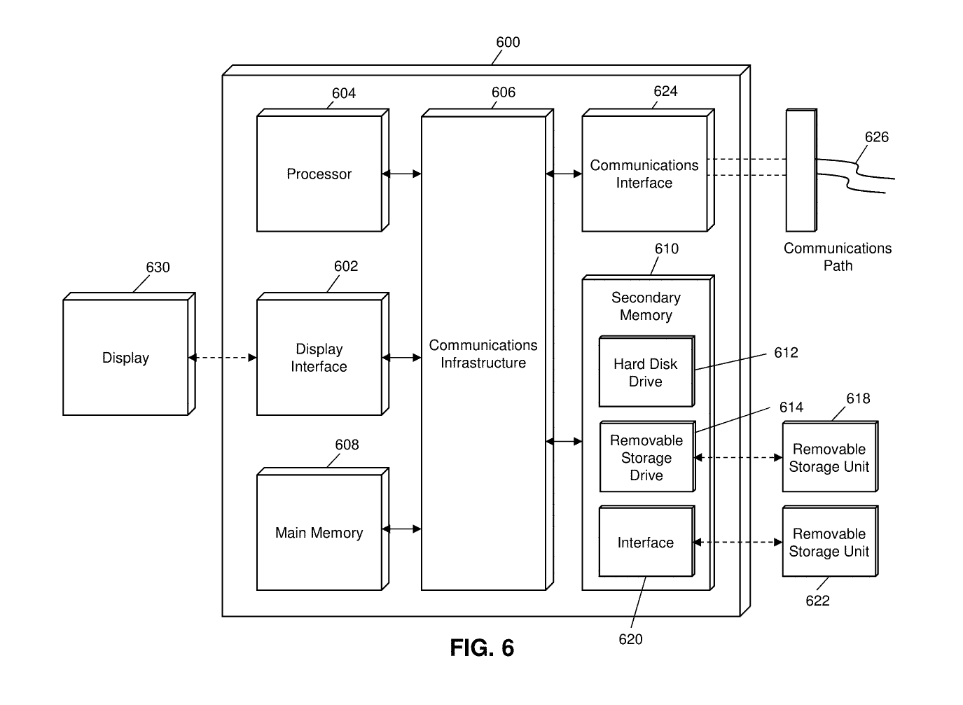

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 600 illustrated in FIG. 6 and discussed in more detail below may be a suitable configuration of the computing device 102.

The computing device 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from merchant systems 106, web servers 108, issuer systems 110, payment networks 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchant systems 106 and/or web servers 108 that may be superimposed or otherwise encoded with web page data. The web page data may include at least a form comprised of a plurality of input fields and additional web page data that may include transaction data, including at least a transaction amount for a payment transaction. The receiving device 202 may also be configured to receive data signals electronically transmitted by issuer systems 110, which may be superimposed or otherwise encoded with a controlled payment number, and, if applicable, additional payment credentials, such as an expiration date and security code.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 212, analytic module 214, data supply module 216, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may also include a memory 206. The memory 206 may be configured to store data for use by the computing device 102 in performing the functions discussed herein. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store program code associated with a web browsing application program, which may be executed by the computing device 102 to navigate to and process the display of web pages. The memory 206 may also be configured to store an account identifier. The account identifier may be a unique value associated with one or more transaction accounts registered with the issuer system 110 for the generation of controlled payment numbers associated therewith. The account identifier may be, for example, a username, e-mail address, telephone number, device identifier, registration number, transaction account number, etc. In some embodiments, the memory 206 may also include additional data for inclusion in web forms to accompany controlled payment numbers, such as a billing address, shipping address, name, etc. The memory 206 may also include additional data suitable for performing the functions discussed herein, such as consumer preferences regarding automatic filling of web forms, the automatic submission of web forms, etc.

The computing device 102 may also include or be otherwise interfaced with a display device 208. The display device 208 may be internal to the computing device 102 or external to the computing device 102 and connected thereto via one or more connections (e.g., wired or wireless) for the transmission of data to and/or from. The display device 208 may be configured to display data to a user of the computing device 102, such as the consumer 104. The display device 208 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 208. The display device 208 may be configured to, for example, display the web page associated with the merchant system 106 used in the initiation of the payment transaction that includes the form in which the controlled payment number is to be submitted.

The computing device 102 may also include or be otherwise be interfaced with one or more input devices 210. The input devices 210 may be internal to the computing device 102 or external to the computing device 102 and connected thereto via one or more connections (e.g., wired or wireless) for the transmission of data to and/or from. The input devices 210 may be configured to receive input from a user of the computing device 102, such as the consumer 104, which may be provided to another module or engine of the processing server 102 (e.g., via the communication module 204) for processing accordingly. Input devices 210 may include any type of input device suitable for receiving input for the performing of the functions discussed herein, such as a keyboard, mouse, click wheel, scroll wheel, microphone, touch screen, track pad, camera, optical imager, etc. The input device 210 may be configured to, for example, receive input from the consumer 104 inputting a controlled payment number (e.g., received from the issuer system 110 via the receiving device 202) into the web page form for submission to the merchant system 106.

The computing device 102 may include a querying module 212. The querying module 212 may be configured to execute queries on databases to identify information. The querying module 212 may receive one or more data values or query strings, and may execute a query string based thereon on an indicated database, such as the memory 206, to identify information stored therein. The querying module 212 may then output the identified information to an appropriate engine or module of the computing device 102 as necessary. The querying module 212 may, for example, execute a query on the memory 206 to identify an account identifier stored therein for transmission to the issuer system 110 for use in generating a controlled payment number.

The computing device 102 may also include an analytic module 214. The analytic module 214 may be configured to perform analysis on data as part of the performance of the functions of the computing device 102 as discussed herein. The analytic module 214 may receive an instruction as to analysis to be performed as input, may perform the instructed analysis, and may output a result of the analysis to another module or engine of the computing device 102. In some instances, the analytic module 214 may receive data on which analytics are to be performed as input. In other instances, the analytic module 214 may be configured to obtain the data, such as by instructing the querying module 212 to execute a query on the memory 206 for the data. The analytic module 214 may be configured to analyze web page data received via the receiving device 202 to identify at least a transaction amount and any other additional transaction data to be used in identifying transaction controls for a controlled payment number.

The computing device 104 may also include a data supply module 216. The data supply module 216 may be configured to supply data to other modules, engines, or devices of the computing device 102 as part of the functions discussed herein. The data supply module 216 may receive an instruction as input, and may supply data as based on that instruction as output. In some instances, the data may accompany the instruction. In other instances, the data supply module 216 may be configured to identify the data being supplied. The data supply module 216 may be configured, for example, to identify a received controlled payment number and any additional data (e.g., billing address, shipping address, name, etc.) to be submitted in a web page form and may supply the data to the web page form via the communication module 204, such as by routing it to the appropriate module or device of the computing device 104 for transmission to the corresponding web server 108 or merchant system 106.

The computing device 102 may also include a transmitting device 218. The transmitting device 218 may be configured to transmit data over one or more networks via one or more network protocols. In some embodiments, the transmitting device 218 may be configured to transmit data over the payment rails, such as using specially configured infrastructure associated with payment networks 112 for the transmission of transaction messages that include sensitive financial data and information, such as identified payment credentials. In some instances, the transmitting device 218 may be configured to transmit data to merchant systems 106, web servers 108, issuer systems 110, payment networks 112, and other entities via alternative networks, such as the Internet. In some embodiments, the transmitting device 218 may be comprised of multiple devices, such as different transmitting devices for transmitting data over different networks, such as a first transmitting device for transmitting data over the payment rails and a second transmitting device for transmitting data over the Internet. The transmitting device 218 may electronically transmit data signals that have data superimposed that may be parsed by a receiving computing device. In some instances, the transmitting device 218 may include one or more modules for superimposing, encoding, or otherwise formatting data into data signals suitable for transmission.

The transmitting device 218 may be configured to electronically transmit data signals to merchant systems 106 and web servers 108 that are superimposed or otherwise encoded with web page requests, which may request a web page as part of the performing of the functions discussed herein. The transmitting device 218 may also electronically transmit data signals to web servers 108 and merchant systems 106 that are superimposed or otherwise encoded with form data as a submission of a form received in web page data, where the form data may include at least a controlled payment number submitted as a primary account number for a payment transaction, and any additional data necessary for the initiation of the payment transaction. The transmitting device 218 may be further configured to electronically transmit data signals to issuer systems 110, which may be superimposed or otherwise encoded with controlled payment number requests. Controlled payment number requests may include at least an account identifier (e.g., queried from the memory 206 by the querying module 212) and a transaction amount and any other web page data (e.g., parsed via the analytic module 214).

### Process for Generation and Usage of a Controlled Payment Number

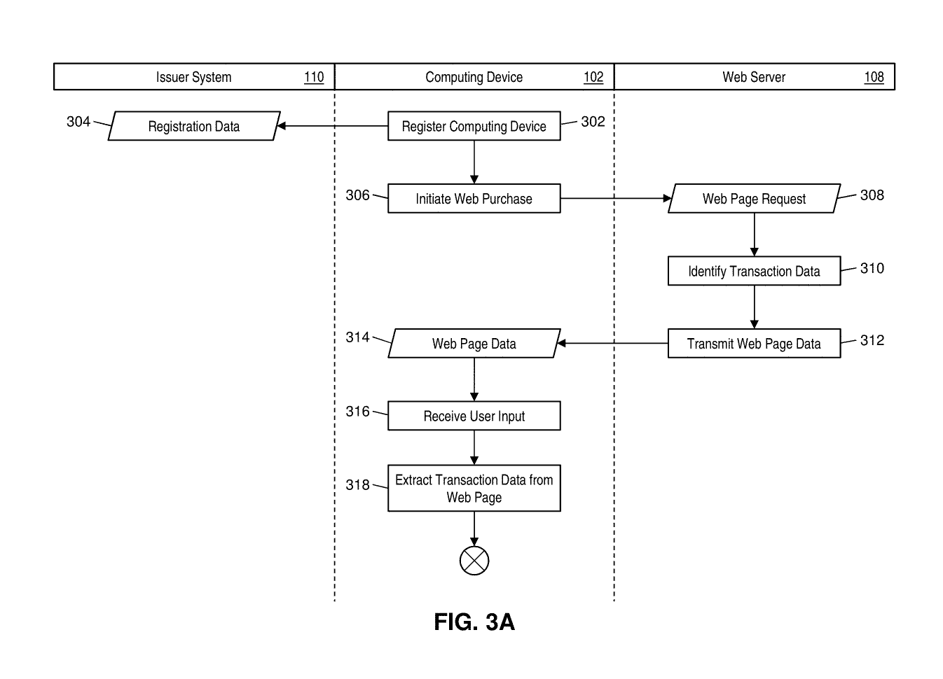

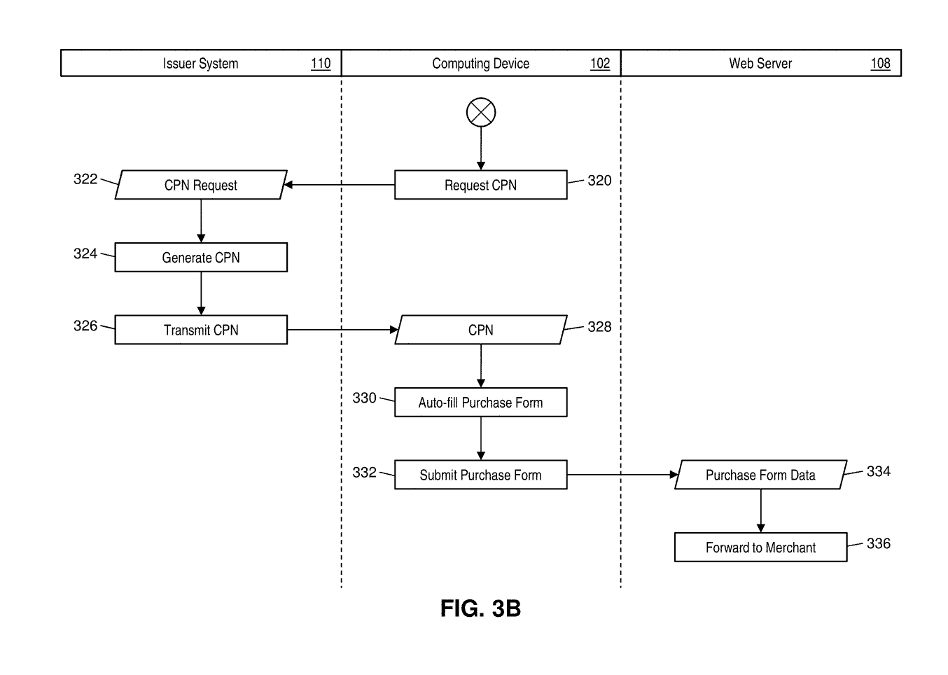

FIG. 3 illustrates a process 300 for the generation and usage of a controlled payment number in the system 100, where generation of the controlled payment number is automatically initiated by the computing device 102 and submitted to a web server 108 for use in a payment transaction.

In step 302, the computing device 102 may be registered with the issuer system 110 for the automatic generation of controlled payment numbers. As part of the registration, the transmitting device 218 of the computing device 102 may electronically transmit a data signal to the issuer system 110 superimposed with at least an account identifier and any other data necessary for the registration of the computing device 102, such as the account number and authentication credentials for a transaction account to which controlled payment numbers are to be associated. Once the computing device 102 is registered, then, in step 306, the computing device 102 may initiate a web purchase via the navigation of the computing device 102 to a web page associated with a merchant system 106 at which purchases may be made. As part of the navigation, the transmitting device 218 may electronically transmit a web page request to the web server 108.

In step 308, the web server 108 may receive the web page request, which may include a uniform resource locator or other data used to indicate the web page being request. In step 310, the web server 108 may identify the web page data for the requested web page, which may include transaction data for a payment transaction that is to be initiated via the web page. The transaction data may be based on additional data stored in the web server 108 or data received from the computing device 102, such as in a database of the web server 108, a cookie received from the computing device 102, etc. For instance, the transaction data may be identified based on a shopping cart for the computing device 102 stored in the web server 102 for the purchase of one or more products. The transaction data may include at least a transaction amount for the payment transaction.

In step 312, the web server 108 may electronically transmit the web page data to the computing device 102 using a suitable communication network and method. In step 314, the receiving device 202 of the computing device 102 may receive the web page data. The web page data may include at least the transaction data as well as a form used for the input of a primary account number and additional data used in the initiation of the payment transaction. In step 316, the input device 210 of the computing device 102 may receive input from the user (e.g., the consumer 104) indicating that a controlled payment number is desired for the payment transaction. In some embodiments, the request may be submitted via an application program associated with the issuer system 110 used to supply the controlled payment numbers. In other embodiments, the request may be submitted via a plug-in or other modification of the web browsing application program.

In step 318, the analytic module 214 may, following the user instruction, extract the transaction amount and any other transaction data from the web page. In some instances, the user may indicate what additional transaction data elements are to be extracted and used in the transaction controls set for the eventual controlled payment number. For example, the consumer 104 may request a control for the merchant, but not for the products being purchased. In step 320, the transmitting device 218 of the computing device 102 may electronically transmit a data signal to the issuer system 110 that is superimposed or otherwise encoded with a request for a controlled payment number (CPN). The request for a controlled payment number may include at least the account identifier used in registration of the computing device 102 and the transaction data parsed from the web page. In some embodiments, the request may be submitted via an application programming interface (API) of the issuer system 110. In step 322, the issuer system 110 may receive the request (e.g., via the API, if applicable).

In step 324, the issuer system 110 may generate or otherwise identify a controlled payment number for use in the payment transaction. The controlled payment number may be associated with the transaction account that corresponds to the account identifier supplied in the request, and may be subject to one or more transaction controls including at least a control in spending that is based on the transaction amount included in the request. In instances where additional transaction data is included in the request, the controlled payment number may be subject to additional transaction controls identified accordingly. In step 326, the issuer system 110 may electronically transmit the generated controlled payment number to the computing device 102, which may be received by the receiving device 202 of the computing device 102 in step 328. In instances where the request is submitted via an API, the controlled payment number may be provided to the computing device 102 via the same API.

In step 330, the data supply module 216 of the computing device 102 may automatically fill in the form in the web page with the controlled payment number and any other data that is available that may be included in the purchase form. In step 332, the transmitting device 218 of the computing device 102 may submit the purchase form via electronically transmitting the form data to the web server 108 using a suitable communication network and method. In step 334, the web server 108 may receive the form data, including the controlled payment number as the primary account number to be used in the payment transaction. In step 336, the web server 108 may forward the transaction data, including the controlled payment number, to the merchant system 106 for processing of the payment transaction using suitable methods.

### Exemplary Method for Automatic Generation and Usage of a Controlled Payment Number

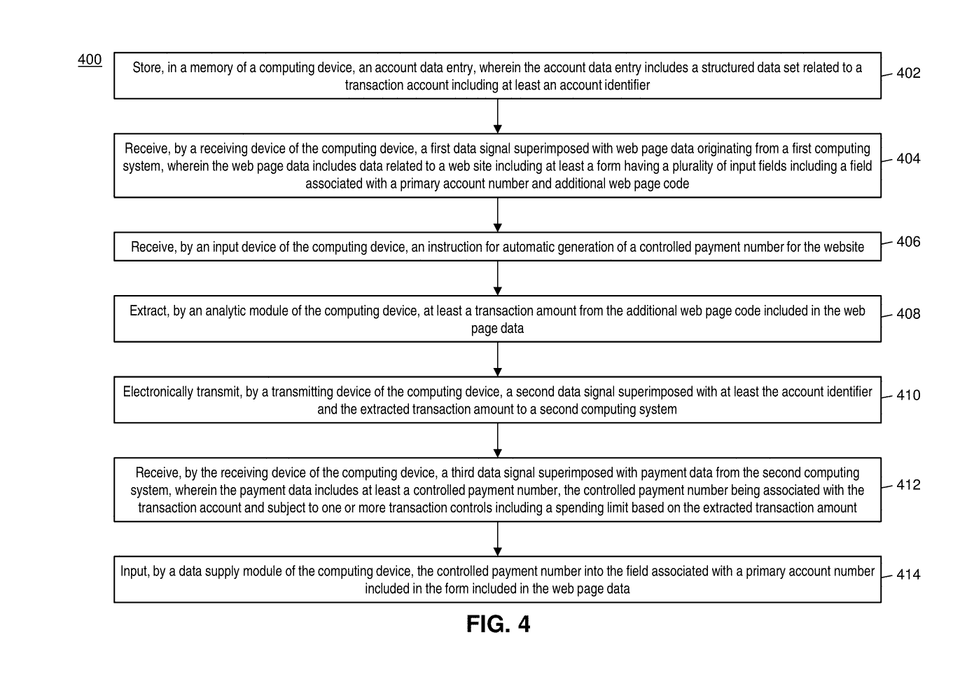

FIG. 4 illustrates a method 400 for the automatic generation and usage of a controlled payment number that is subject to transaction controls that are based on data read from a web page used to initiate a payment transaction.

In step 402, an account data entry may be stored in a memory (e.g., the memory 206) of a computing device (e.g., the computing device 102), wherein the account data entry includes a structured data set related to a transaction account including at least an account identifier. In step 404, a first data signal may be received by a receiving device (e.g., the receiving device 202) of the computing device that is superimposed with web page data and originating from a first computing system (e.g., the web server 108 or merchant system 106), wherein the web page data includes data related to a web site including at least a form having a plurality of input fields including a field associated with a primary account number and additional web page code.

In step 406, an instruction for automatic generation of a controlled payment number for the website may be received by an input device (e.g., the input device 210) of the computing device. In step 408, at least the transaction amount may be extracted by an analytic module (e.g., the analytic module 214) of the computing device from the additional web page code included in the web page data. In step 410, a second data signal superimposed with at least the account identifier and the extracted transaction amount may be electronically transmitted by a transmitting device (e.g., the transmitting device 218) of the computing device to a second computing system (e.g., the issuer system 110).

In step 412, a third data signal superimposed with payment data may be received by the receiving device of the computing device from the second computing system, wherein the payment data includes at least a controlled payment number, the controlled payment number being associated with the transaction account and subject to one or more transaction controls including a spending limit based on the extracted transaction amount. In step 414, the controlled payment number may be input, by a data supply module (e.g., the data supply module 216) of the computing device, into the field associated with a primary account number included in the form included in the web page data.

In one embodiment, the method 400 may further include submitting, by the transmitting device of the computing device, the form included in the web page data. In a further embodiment, the transmitting device of the computing device may be configured to automatically submit the form upon input of the controlled payment number by the data supply module of the computing device. In some embodiments, the data supply module of the computing device may be configured to automatically input the controlled payment number into the field associated with a primary account number upon receipt of the third data signal.

In one embodiment, the second data signal may be electronically transmitted to the second computing system via an application programming interface operated by the second computing system. In some embodiments, extraction of the transaction amount may further include extraction of merchant data from the additional web page code included in the web page data, and the one or more transaction controls may include a merchant control associated with a merchant corresponding to the extracted merchant data. In one embodiment, the one or more transaction controls may include a time control limiting usage of the controlled payment number to a predetermined period of time within transmission of the second data signal.

In some embodiments, the controlled payment number may be a single-use controlled payment number. In one embodiment, the account data entry may further include at least a billing name and billing address, the plurality of input fields may further include a second field associated with a name and a third field associated with an address, and input of the controlled payment number into the field associated with a primary account number may further include input of the billing name into the second field associated with a name and input of the billing address into the third field associated with an address. In some embodiments, the plurality of input fields may further include a second field associated with a security code, the payment data may further include a code number associated with the controlled payment number, and input of the controlled payment number into the field associated with a primary account number may further include input of the code number into the second field associated with a security code.

### Payment Transaction Processing System and Process

FIG. 5 illustrates a transaction processing system and a process 500 for the processing of payment transactions in the system, which may include the processing of thousands, millions, or even billions of transactions during a given period (e.g., hourly, daily, weekly, etc.). The process 500 and steps included therein may be performed by one or more components of the system 100 discussed above, such as the computing device 102, consumer 104, merchant system 106, issuer system 110, payment network 112, etc. The processing of payment transactions using the system and process 500 illustrated in FIG. 5 and discussed below may utilize the payment rails, which may be comprised of the computing devices and infrastructure utilized to perform the steps of the process 500 as specially configured and programmed by the entities discussed below, including the transaction processing server 512, which may be associated with one or more payment networks configured to processing payment transactions. It will be apparent to persons having skill in the relevant art that the process 500 may be incorporated into the processes illustrated in FIGS. 3 and 4, discussed above, with respect to the step or steps involved in the processing of a payment transaction. In addition, the entities discussed herein for performing the process 500 may include one or more computing devices or systems configured to perform the functions discussed below. For instance, the merchant 506 may be comprised of one or more point of sale devices, a local communication network, a computing server, and other devices configured to perform the functions discussed below.

In step 520, an issuing financial institution 502 may issue a payment card or other suitable payment instrument to a consumer 504. The issuing financial institution may be a financial institution, such as a bank, or other suitable type of entity that administers and manages payment accounts and/or payment instruments for use with payment accounts that can be used to fund payment transactions. The consumer 504 may have a transaction account with the issuing financial institution 502 for which the issued payment card is associated, such that, when used in a payment transaction, the payment transaction is funded by the associated transaction account. In some embodiments, the payment card may be issued to the consumer 504 physically. In other embodiments, the payment card may be a virtual payment card or otherwise provisioned to the consumer 504 in an electronic format.

In step 522, the consumer 504 may present the issued payment card to a merchant 506 for use in funding a payment transaction. The merchant 506 may be a business, another consumer, or any entity that may engage in a payment transaction with the consumer 504. The payment card may be presented by the consumer 504 via providing the physical card to the merchant 506, electronically transmitting (e.g., via near field communication, wireless transmission, or other suitable electronic transmission type and protocol) payment details for the payment card, or initiating transmission of payment details to the merchant 506 via a third party. The merchant 506 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 524, the merchant 506 may enter transaction details into a point of sale computing system. The transaction details may include the payment details provided by the consumer 504 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 506 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 506 may be an online retailer in an e-commerce transaction. In such embodiments, the transaction details may be entered in a shopping cart or other repository for storing transaction data in an electronic transaction as will be apparent to persons having skill in the relevant art.

In step 526, the merchant 506 may electronically transmit a data signal superimposed with transaction data to a gateway processor 508. The gateway processor 508 may be an entity configured to receive transaction details from a merchant 506 for formatting and transmission to an acquiring financial institution 510. In some instances, a gateway processor 508 may be associated with a plurality of merchants 506 and a plurality of acquiring financial institutions 510. In such instances, the gateway processor 508 may receive transaction details for a plurality of different transactions involving various merchants, which may be forwarded on to appropriate acquiring financial institutions 510. By having relationships with multiple acquiring financial institutions 510 and having the requisite infrastructure to communicate with financial institutions using the payment rails, such as using application programming interfaces associated with the gateway processor 508 or financial institutions used for the submission, receipt, and retrieval of data, a gateway processor 508 may act as an intermediary for a merchant 506 to be able to conduct payment transactions via a single communication channel and format with the gateway processor 508, without having to maintain relationships with multiple acquiring financial institutions 510 and payment processors and the hardware associated thereto. Acquiring financial institutions 510 may be financial institutions, such as banks, or other entities that administers and manages payment accounts and/or payment instruments for use with payment accounts. In some instances, acquiring financial institutions 510 may manage transaction accounts for merchants 506. In some cases, a single financial institution may operate as both an issuing financial institution 502 and an acquiring financial institution 510.

The data signal transmitted from the merchant 506 to the gateway processor 508 may be superimposed with the transaction details for the payment transaction, which may be formatted based on one or more standards. In some embodiments, the standards may be set forth by the gateway processor 508, which may use a unique, proprietary format for the transmission of transaction data to/from the gateway processor 508. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 508.

In step 528, the gateway processor 508 may parse the transaction data signal to obtain the transaction data superimposed thereon and may format the transaction data as necessary. The formatting of the transaction data may be performed by the gateway processor 508 based on the proprietary standards of the gateway processor 508 or an acquiring financial institution 510 associated with the payment transaction. The proprietary standards may specify the type of data included in the transaction data and the format for storage and transmission of the data. The acquiring financial institution 510 may be identified by the gateway processor 508 using the transaction data, such as by parsing the transaction data (e.g., deconstructing into data elements) to obtain an account identifier included therein associated with the acquiring financial institution 510. In some instances, the gateway processor 508 may then format the transaction data based on the identified acquiring financial institution 510, such as to comply with standards of formatting specified by the acquiring financial institution 510. In some embodiments, the identified acquiring financial institution 510 may be associated with the merchant 506 involved in the payment transaction, and, in some cases, may manage a transaction account associated with the merchant 506.

In step 530, the gateway processor 508 may electronically transmit a data signal superimposed with the formatted transaction data to the identified acquiring financial institution 510. The acquiring financial institution 510 may receive the data signal and parse the signal to obtain the formatted transaction data superimposed thereon. In step 532, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 506 involved in the payment transaction is requesting payment or a promise of payment from the issuing financial institution 502 for the transaction. The authorization request may include a plurality of data elements, each data element being configured to store data as set forth in the associated standards, such as for storing an account number, application cryptogram, transaction amount, issuing financial institution 502 information, etc.

In step 534, the acquiring financial institution 510 may electronically transmit the authorization request to a transaction processing server 512 for processing. The transaction processing server 512 may be comprised of one or more computing devices as part of a payment network configured to process payment transactions. In some embodiments, the authorization request may be transmitted by a transaction processor at the acquiring financial institution 510 or other entity associated with the acquiring financial institution. The transaction processor may be one or more computing devices that include a plurality of communication channels for communication with the transaction processing server 512 for the transmission of transaction messages and other data to and from the transaction processing server 512. In some embodiments, the payment network associated with the transaction processing server 512 may own or operate each transaction processor such that the payment network may maintain control over the communication of transaction messages to and from the transaction processing server 512 for network and informational security.

In step 536, the transaction processing server 512 may perform value-added services for the payment transaction. Value-added services may be services specified by the issuing financial institution 502 that may provide additional value to the issuing financial institution 502 or the consumer 504 in the processing of payment transactions. Value-added services may include, for example, fraud scoring, transaction or account controls, account number mapping, offer redemption, loyalty processing, etc. For instance, when the transaction processing server 512 receives the transaction, a fraud score for the transaction may be calculated based on the data included therein and one or more fraud scoring algorithms and/or engines. In some instances, the transaction processing server 512 may first identify the issuing financial institution 502 associated with the transaction, and then identify any services indicated by the issuing financial institution 502 to be performed. The issuing financial institution 502 may be identified, for example, by data included in a specific data element included in the authorization request, such as an issuer identification number. In another example, the issuing financial institution 502 may be identified by the primary account number stored in the authorization request, such as by using a portion of the primary account number (e.g., a bank identification number) for identification.

In step 538, the transaction processing server 512 may electronically transmit the authorization request to the issuing financial institution 502. In some instances, the authorization request may be modified, or additional data included in or transmitted accompanying the authorization request as a result of the performance of value-added services by the transaction processing server 512. In some embodiments, the authorization request may be transmitted to a transaction processor (e.g., owned or operated by the transaction processing server 512) situated at the issuing financial institution 502 or an entity associated thereof, which may forward the authorization request to the issuing financial institution 502.

In step 540, the issuing financial institution 502 may authorize the transaction account for payment of the payment transaction. The authorization may be based on an available credit amount for the transaction account and the transaction amount for the payment transaction, fraud scores provided by the transaction processing server 512, and other considerations that will be apparent to persons having skill in the relevant art. The issuing financial institution 502 may modify the authorization request to include a response code indicating approval (e.g., or denial if the transaction is to be denied) of the payment transaction. The issuing financial institution 502 may also modify a message type indicator for the transaction message to indicate that the transaction message is changed to be an authorization response. In step 542, the issuing financial institution 502 may transmit (e.g., via a transaction processor) the authorization response to the transaction processing server 512.

In step 544, the transaction processing server 512 may forward the authorization response to the acquiring financial institution 510 (e.g., via a transaction processor). In step 546, the acquiring financial institution may generate a response message indicating approval or denial of the payment transaction as indicated in the response code of the authorization response, and may transmit the response message to the gateway processor 508 using the standards and protocols set forth by the gateway processor 508. In step 548, the gateway processor 508 may forward the response message to the merchant 506 using the appropriate standards and protocols. In step 550, assuming the transaction was approved, the merchant 506 may then provide the products purchased by the consumer 504 as part of the payment transaction to the consumer 504.

In some embodiments, once the process 500 has completed, payment from the issuing financial institution 502 to the acquiring financial institution 510 may be performed. In some instances, the payment may be made immediately or within one business day. In other instances, the payment may be made after a period of time, and in response to the submission of a clearing request from the acquiring financial institution 510 to the issuing financial institution 502 via the transaction processing server 502. In such instances, clearing requests for multiple payment transactions may be aggregated into a single clearing request, which may be used by the transaction processing server 512 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 540), the transaction processing server 512 may be configured to perform authorization of transactions on behalf of the issuing financial institution 502. Such actions may be referred to as “stand-in processing,” where the transaction processing server “stands in” as the issuing financial institution 502. In such instances, the transaction processing server 512 may utilize rules set forth by the issuing financial institution 502 to determine approval or denial of the payment transaction, and may modify the transaction message accordingly prior to forwarding to the acquiring financial institution 510 in step 544. The transaction processing server 512 may retain data associated with transactions for which the transaction processing server 512 stands in, and may transmit the retained data to the issuing financial institution 502 once communication is reestablished. The issuing financial institution 502 may then process transaction accounts accordingly to accommodate for the time of lost communication.

In another example, if the transaction processing server 512 is unavailable for submission of the authorization request by the acquiring financial institution 510, then the transaction processor at the acquiring financial institution 510 may be configured to perform the processing of the transaction processing server 512 and the issuing financial institution 502. The transaction processor may include rules and data suitable for use in making a determination of approval or denial of the payment transaction based on the data included therein. For instance, the issuing financial institution 502 and/or transaction processing server 512 may set limits on transaction type, transaction amount, etc. that may be stored in the transaction processor and used to determine approval or denial of a payment transaction based thereon. In such instances, the acquiring financial institution 510 may receive an authorization response for the payment transaction even if the transaction processing server 512 is unavailable, ensuring that transactions are processed and no downtime is experienced even in instances where communication is unavailable. In such cases, the transaction processor may store transaction details for the payment transactions, which may be transmitted to the transaction processing server 512 (e.g., and from there to the associated issuing financial institutions 502) once communication is reestablished.

In some embodiments, transaction processors may be configured to include a plurality of different communication channels, which may utilize multiple communication cards and/or devices, to communicate with the transaction processing server 512 for the sending and receiving of transaction messages. For example, a transaction processor may be comprised of multiple computing devices, each having multiple communication ports that are connected to the transaction processing server 512. In such embodiments, the transaction processor may cycle through the communication channels when transmitting transaction messages to the transaction processing server 512, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 510 may identify that an authorization request involves an issuing financial institution 502 (e.g., via the bank identification number included in the transaction message) for which no value-added services are required. The transaction processor at the acquiring financial institution 510 may then transmit the authorization request directly to the transaction processor at the issuing financial institution 502 (e.g., without the authorization request passing through the transaction processing server 512), where the issuing financial institution 502 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 512 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 508, acquiring financial institution 510, etc.) for processing using this advanced network, and to quickly and efficiently receive a response regarding the ability for a consumer 504 to fund the payment transaction.

### Computer System Architecture

FIG. 6 illustrates a computer system 600 in which embodiments of the present disclosure, or portions thereof, may be implemented as computer-readable code. For example, the computing device 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for automatic generation and usage of a controlled payment number. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automatic generation and usage of a controlled payment number, comprising:
storing, in a memory of a computing device, an account data entry, wherein the account data entry includes a structured data set related to a transaction account including at least an account identifier;
receiving, by a receiving device of the computing device, a first data signal superimposed with web page data originating from a first computing system, wherein the web page data includes data related to a web site including at least a form having a plurality of input fields including a field associated with a primary account number and additional web page code;
receiving, by an input device of the computing device, an instruction for automatic generation of a controlled payment number for use with the website;
extracting, by an analytic module of the computing device, at least a transaction amount from the additional web page code included in the web page data;
electronically transmitting, by a transmitting device of the computing device, a second data signal superimposed with at least the account identifier and the extracted transaction amount to a second computing system;
receiving, by the receiving device of the computing device, a third data signal superimposed with payment data from the second computing system, wherein the payment data includes at least a controlled payment number, the controlled payment number being associated with the transaction account and subject to one or more transaction controls including a spending limit based on the extracted transaction amount; and
inputting, by a data supply module of the computing device, the controlled payment number into the field associated with a primary account number included in the form included in the web page data.

2. The method of claim 1, further comprising:
submitting, by the transmitting device of the computing device, the form included in the web page data.

3. The method of claim 2, wherein the transmitting device of the computing device is configured to automatically submit the form upon input of the controlled payment number by the data supply module of the computing device.

4. The method of claim 1, wherein the data supply module of the computing device is configured to automatically input the controlled payment number into the field associated with a primary account number upon receipt of the third data signal.

5. The method of claim 1, wherein the second data signal is electronically transmitted to the second computing system via an application programming interface operated by the second computing system.

6. The method of claim 1, wherein
extraction of the transaction amount further includes extraction of merchant data from the additional web page code included in the web page data, and
the one or more transaction controls includes a merchant control associated with a merchant corresponding to the extracted merchant data.

7. The method of claim 1, wherein the one or more transaction controls includes a time control limiting usage of the controlled payment number to a predetermined period of time within transmission of the second data signal.

8. The method of claim 1, wherein the controlled payment number is a single-use controlled payment number.

9. The method of claim 1, wherein
the account data entry further includes at least a billing name and billing address,
the plurality of input fields further includes a second field associated with a name and a third field associated with an address, and
input of the controlled payment number into the field associated with a primary account number further includes input of the billing name into the second field associated with a name and input of the billing address into the third field associated with an address.

10. The method of claim 1, wherein
the plurality of input fields further includes a second field associated with a security code,
the payment data further includes a code number associated with the controlled payment number, and
input of the controlled payment number into the field associated with a primary account number further includes input of the code number into the second field associated with a security code.

11. A system for automatic generation and usage of a controlled payment number, comprising:
a data supply module of a computing device;
a memory of the computing device configured to store an account data, wherein the account data entry includes a structured data set related to a transaction account including at least an account identifier;
a receiving device of the computing device configured to receive a first data signal superimposed with web page data originating from a first computing system, wherein the web page data includes data related to a web site including at least a form having a plurality of input fields including a field associated with a primary account number and additional web page code;
an input device of the computing device configured to receive an instruction for automatic generation of a controlled payment number for use with the website;
an analytic module of the computing device configured to extract at least a transaction amount from the additional web page code included in the web page data; and
a transmitting device of the computing device configured to electronically transmit a second data signal superimposed with at least the account identifier and the extracted transaction amount to a second computing system, wherein
the receiving device of the computing device is further configured to receive a third data signal superimposed with payment data from the second computing system, wherein the payment data includes at least a controlled payment number, the controlled payment number being associated with the transaction account and subject to one or more transaction controls including a spending limit based on the extracted transaction amount, and
the data supply module of the computing device is configured to input the controlled payment number into the field associated with a primary account number included in the form included in the web page data.

12. The system of claim 11, wherein the transmitting device of the computing device is further configured to submit the form included in the web page data.

13. The system of claim 12, wherein the transmitting device of the computing device is further configured to automatically submit the form upon input of the controlled payment number by the data supply module of the computing device.

14. The system of claim 11, wherein the data supply module of the computing device is further configured to automatically input the controlled payment number into the field associated with a primary account number upon receipt of the third data signal.

15. The system of claim 11, wherein the second data signal is electronically transmitted to the second computing system via an application programming interface operated by the second computing system.

16. The system of claim 11, wherein
extraction of the transaction amount further includes extraction of merchant data from the additional web page code included in the web page data, and
the one or more transaction controls includes a merchant control associated with a merchant corresponding to the extracted merchant data.

17. The system of claim 11, wherein the one or more transaction controls includes a time control limiting usage of the controlled payment number to a predetermined period of time within transmission of the second data signal.

18. The system of claim 11, wherein the controlled payment number is a single-use controlled payment number.

19. The system of claim 11, wherein
the account data entry further includes at least a billing name and billing address,
the plurality of input fields further includes a second field associated with a name and a third field associated with an address, and
input of the controlled payment number into the field associated with a primary account number further includes input of the billing name into the second field associated with a name and input of the billing address into the third field associated with an address.

20. The system of claim 11, wherein
the plurality of input fields further includes a second field associated with a security code,
the payment data further includes a code number associated with the controlled payment number, and
input of the controlled payment number into the field associated with a primary account number further includes input of the code number into the second field associated with a security code.
